(19) United States
(12) Patent Application Publication
(10) Pub. No.: US 2025/0269391 A1
(43) Pub. Date: Aug. 28, 2025

(54) SYSTEM FOR CONNECTING A CONTAINER TO A DISPENSING DEVICE, CONTAINER, AND DISPENSING DEVICE

(71) Applicant: ALPLA Werke Alwin Lehner GmbH & Co. KG, Hard (AT)

(72) Inventors: Christian SCHARINGER, Hard (AT); Danilo GRIECO, Dornbirn (AT); Oliver UNTERLECHNER, Bregenz (AT)

(73) Assignee: ALPLA Werke Alwin Lehner GmbH & Co. KG, Hard (AT)

(21) Appl. No.: 18/876,911

(22) PCT Filed: Jun. 23, 2023
(86) PCT No.: PCT/EP2023/067186

§ 371 Date: Dec. 19, 2024

(30) Foreign Application Priority Data
Jun. 24, 2022 (CH) 000760/2022

(51) Int. Cl. B05B 11/00; B05B 11/10

(52) U.S. Cl. CPC B05B 11/0054; B05B 11/0038; B05B 11/1047

(57) ABSTRACT

The invention relates to a system (100) for connecting a container (20) to a dispensing device (30). The invention also relates to a container (20) and to a receiving device (50). The system comprises a main body (21) situated on the container (20), and a connection element (31) situated on the dispensing device (30). The connection element (31) is in operative connection with, or can be brought into operative connection with, the main body (21). Mutually complementary engagement means (22, 32) are situated on the main body (21) and on the connection element (31) such that a fluid-tight connection is produced between the main body (21) and the connection element (31) when the engagement means (22, 32) mutually engage.

The present invention relates to a system for connecting a container to a dispensing device, a container for use in an aforementioned system and a receiving device for receiving the aforementioned container according to the preamble of the independent claims.

Society has long felt the need to conserve resources and to use everyday objects more than once. For this reason, systems that can be refilled have become established on the market. Typically, a valuable and robust container is provided in which, for example, a liquid such as hand soap can be received. Such containers are typically equipped with a device for dispensing the liquid, such as a pump dispenser or a spray dispenser.

So that the system can be reused, the device for dispensing the liquid is removed from the container and the container is refilled from a refill pack with a product corresponding to the original product. Refill packs are often pouches made of a thin film, which use significantly less material than reusable containers.

During this refilling process, there is always a risk that the reusable container will become soiled and/or the user will get product on himself.

The dispensing device is typically equipped with a riser tube so that the product can be removed from the reusable container. Residues of the liquid that was previously in the reusable container will typically always adhere to this riser tube. Accordingly, there is also a risk that the user will get product on himself. For a product change, the entire dispensing device and the reusable container must be cleaned, which can involve considerable effort.

It is therefore an object of the invention to eliminate at least one or more disadvantages of the prior art. In particular, a container and a system for connecting a container to a dispensing device are to be created, which makes it possible to reduce the amount of material required and, in particular, makes it possible to reduce soiling during the refilling process.

This object is achieved by the devices defined in the independent claims. Further embodiments result from the dependent claims.

A system according to the invention for connecting a container to a dispensing device comprises a main body situated on the container and a connection element situated on the dispensing device. The connection element is in operative connection with, or can be brought into operative connection with, the main body. Mutually complementary engagement means are situated on the main body and on the connection element such that a fluid-tight connection is produced between the main body and the connection element when the engagement means mutually engage.

A fluid-tight connection makes it possible to connect a container to a dispensing device in such a way that a product to be dispensed can be dispensed from the container with the dispensing device without it getting on the user.

It can be provided that the system has a sealing element to create the fluid-tight connection. The sealing element is preferably situated in such a way that it makes sealing contact with the connection element and the main body.

Manufacturing tolerances can be easily accommodated with a sealing element.

The sealing element can be situated on the main body. Due to the arrangement on the main body, it is ensured that a new sealing element is used each time the container is replaced, thus repeatedly ensuring the sealing effect.

Alternatively, the sealing element can be situated on the connection element. If the sealing element is designed accordingly, it can be used over the entire service life of the system. This saves both costs and resources.

The sealing element can be designed as a surface seal. Such seals are available as semi-finished products, are easy to manufacture and inexpensive to produce.

Alternatively, it is also possible to provide the sealing element by means of a form fit or a force fit, for example by the interlocking of two conical elements, for example a conical connecting piece into a corresponding conical opening. A sealing effect can also be produced by pressing two sealing surfaces together.

The container can be designed as a flexible container. Flexible containers are typically made from films welded together. Flexible containers of this type can be manufactured with extremely low material costs. This also leads to a low volume of waste. Since such flexible containers are only used in the form of a refill pouch, they do not have to meet any special requirements in terms of inherent strength and can therefore be manufactured using less material.

A flexible container can also be easily emptied after being connected to the dispensing device. Since the connection to the dispensing device is fluid-tight, the volume of the flexible container is reduced when the product is dispensed, since there is no air exchange into the container. In other words, the container will fold up so that the product can substantially be dispensed in its entirety.

Alternatively, the container can also be designed as a dimensionally stable container. Due to the design as a dimensionally stable container, the user can be provided with an easy-to-handle refill container.

It can be provided that a riser tube is situated in the dimensionally stable container. Since the dimensionally stable container is not resilient and flexible, the product in the region of the base of the container must be removed in order to empty it completely.

It can be provided that the riser tube is designed as a component of the container and is arranged in a manner integrated into it. The riser tube is preferably connected to the main body.

In contrast to the prior art, due to this configuration, the riser tube does not have to be cleaned or removed from the reusable container after use, since it remains in the container.

The engagement means can be designed as a screwed connection.

A screwed connection makes a secure connection possible between the main body and the connection element, without the need for any other additional elements.

Alternatively, the engagement means can be designed as a slide-on connection. A slide-on connection makes it possible to slide the connection element laterally over the main body. By definition, lateral sliding means sliding at right angles to the longitudinal axis of the container. By definition, the longitudinal axis of the container is defined by a connection between a base and a dispensing opening of the container.

Alternatively, the engagement means can be designed as a plug-in connection. In the present case, a plug-in connection means a connection with a movement in the direction of the longitudinal axis. In other words, the engagement means can be designed in such a way that for example a connecting piece projects from the connection element, which connecting piece can be inserted into a corresponding opening in the main body. In this case, the sealing effect is produced between the outer surfaces of the connecting piece and an inner surface of the opening.

Alternatively, the engagement means can be designed as a bayonet closure. A bayonet closure is easy to use and also makes a secure connection possible.

In all embodiments, it can be provided that a projection and/or a constriction is formed on the engagement means in order to produce a snap connection. By providing a snap connection, accidental opening or release of the mutually engaged engagement means can be prevented to a certain extent. In addition, the user can be given tactile feedback such that he is informed about the secure connection of the main body to the connection element.

The main body can be non-detachably connected to the container, in particular can be an integral component.

A non-detachable connection ensures that the container can be manipulated easily and safely. Manufacturing as an integral component makes it possible to further reduce material costs.

The dispensing device can be designed as a metering device. Preferably, the dispensing device is designed as a pump dispenser or as a spray dispenser. This corresponding design is advantageous for the user, since once the engagement means have been engaged, the user has a ready-to-use system.

The system can comprise a receiving device for receiving the container.

The receiving device can be designed to be appealing to the user. In addition, the receiving device can be used to provide a vessel or a holding device that can receive the container, which is manufactured with little outlay on material, in particular as a refill container. In other words, the receiving device can be designed for multiple use and have a corresponding stability. Accordingly, the container described in the present case no longer has to meet high strength requirements, since any forces that arise can be absorbed by the receiving device.

It can be provided that the dispensing device is situated on the receiving device. In particular, a part of the receiving device forms a component of the dispensing device.

The arrangement of the dispensing device on the receiving device allows the provision of a reusable dispensing device as a component of a vessel or holding device, which can receive a container as described in the present case.

In its interior, the receiving device can have an extension between a base of the receiving device and the connection element of the dispensing device, which extension is shorter than an associated extension of a container, such that the container can be clamped inside the receiving device. In particular, the container is clamped or can be clamped inside the receiving device between a base of the receiving device and the connection element. This makes it possible to exert a permanent preload on the engagement means, such that they are pressed together.

In particular, the receiving device can be designed in two parts. A first component of the receiving device is manufactured together with the dispensing device, or these elements are arranged next to one another.

Such an embodiment is particularly advantageous if the engagement means are designed as a plug-in connection. A container can be inserted into the receiving device and by joining the receiving device together, the plug-in connection can be brought into operative connection and the fluid-tight connection can be maintained by the clamping effect.

A further aspect relates to a container, in particular for use in a system as described in the present case. The container has a main body for connection to a connection element situated on a dispensing device. Engagement means are situated on the main body, which engagement means can be brought into engagement with complementary engagement means on the connection element.

By providing complementary engagement means on the main body, it can be easily connected to a corresponding dispensing device, for example.

The container can be in the form of a flexible pouch. Flexible pouches can be manufactured from very thin materials and thus reduce the environmental impact by using less material. In addition, a flexible pouch allows the contents to be dispensed essentially completely.

Alternatively, the container can be designed as a dimensionally stable container.

The dimensional stability makes it possible for the container to interact with a corresponding receiving device, for example. A dimensionally stable container also makes it easier for a user to manipulate the container.

For complete emptying of the container, a riser tube can be situated in the dimensionally stable container. Said riser tube ends in particular in the region of a base of the dimensionally stable container.

The engagement means on the container can be designed as one half of a screwed connection. Alternatively, the engagement means can be designed as one half of a slide-on connection. In a further alternative, the engagement means can be designed as one half of a bayonet closure. Again, in a further alternative, the engagement means can be designed as one half of a plug-in connection. It goes without saying that the respective other half of the engagement means is situated on a corresponding counterpart, in the present case on a connection element situated on a dispensing device.

All of these alternatives make a secure connection possible, wherein a screwed connection, for example, is suitable for doing without additional elements. A slide-on connection makes the simple joining of corresponding elements possible, as already described in relation to the system. The advantages of a bayonet closure and a plug-in connection have also already been described in relation to the system and are fully applicable to a container.

A projection and/or a constriction can be formed on the engagement means for producing a snap connection. A snap connection forms a certain degree of protection against accidental opening and can also provide the user with tactile feedback that allows the user to recognize the secure connection of two elements, in this case a dispensing device and a container.

The main body is preferably non-detachably connected to the container and, in particular, is designed as an integral component of the container. This makes manufacturing easier and prevents incorrect manipulation by the user.

A further aspect relates to a receiving device for receiving a container, in particular a container as described as in the present case. The receiving device comprises a dispensing device. The combination of the receiving device and dispensing device provides a vessel or holding device into which a refill container can be easily inserted. The receiving device can thus provide an element that is sufficiently strong for repeated use and is not soiled by the dispensed product. In this case, this is typically provided in a container as described in the present case, a refill container.

The receiving device can be formed from two components, such that the insertion or receiving of the container is simplified. These components can form a receiving part and a closing part, wherein the dispensing device is situated on the closing part.

The closing part and the receiving part can be connected to one another via a bayonet closure or a screwed connection. Both connections make it possible for the receiving part to be securely connected to the closing part.

In its interior, the receiving device can have an extension between a base of the receiving device and the connection element of the dispensing device that is shorter than an associated extension of a container, such that the container can be clamped inside the receiving device, in particular between the base of the receiving device and the connection element of the dispensing device.

Such an embodiment is particularly advantageous if the engagement means are designed as a plug-in connection. A container can be inserted into the receiving device and by joining the receiving device together, the plug-in connection can be brought into operative connection and the fluid-tight connection can be maintained by the clamping effect.

The invention is explained below with reference to schematic figures; in the figures:

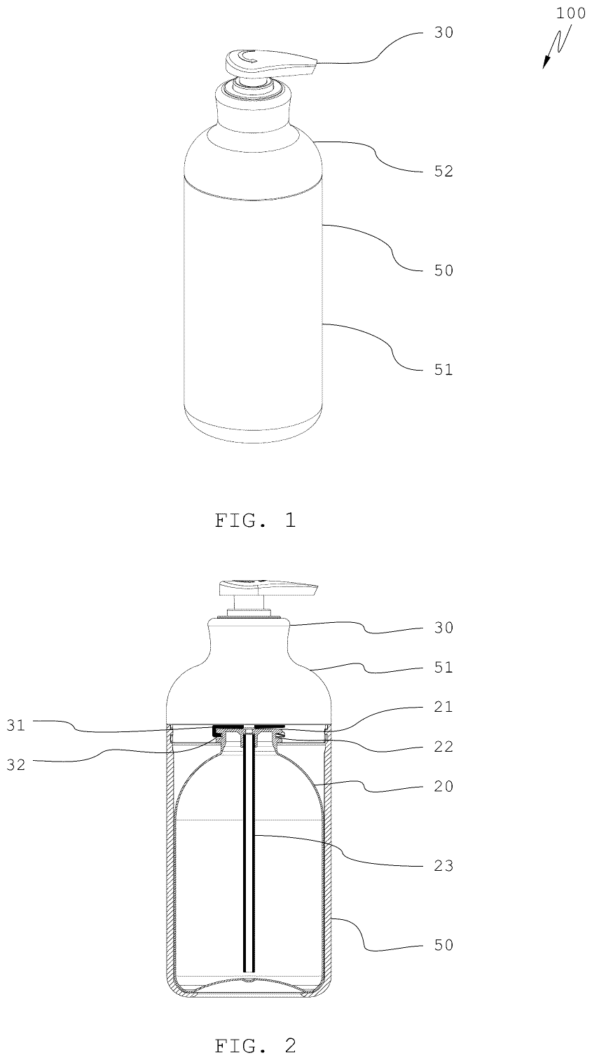

FIG. 1: shows a perspective view of a system together with a receiving device;

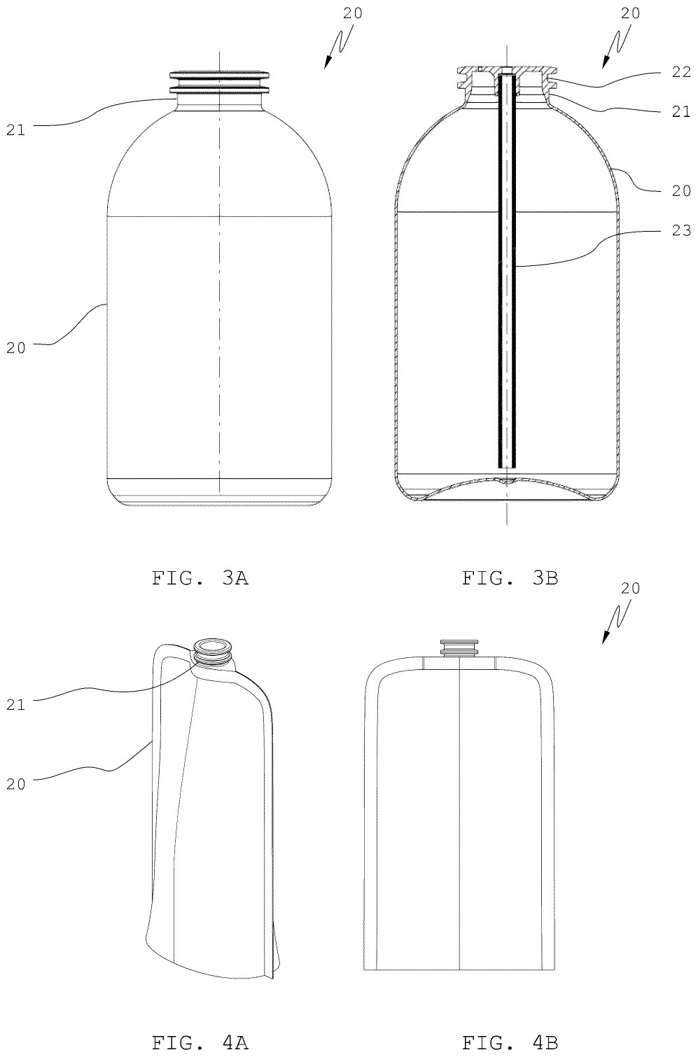

FIG. 2: shows a sectional view through the system according to FIG. 1;

FIGS. 3A and 3B: show a side view and a sectional representation of a dimensionally stable container;

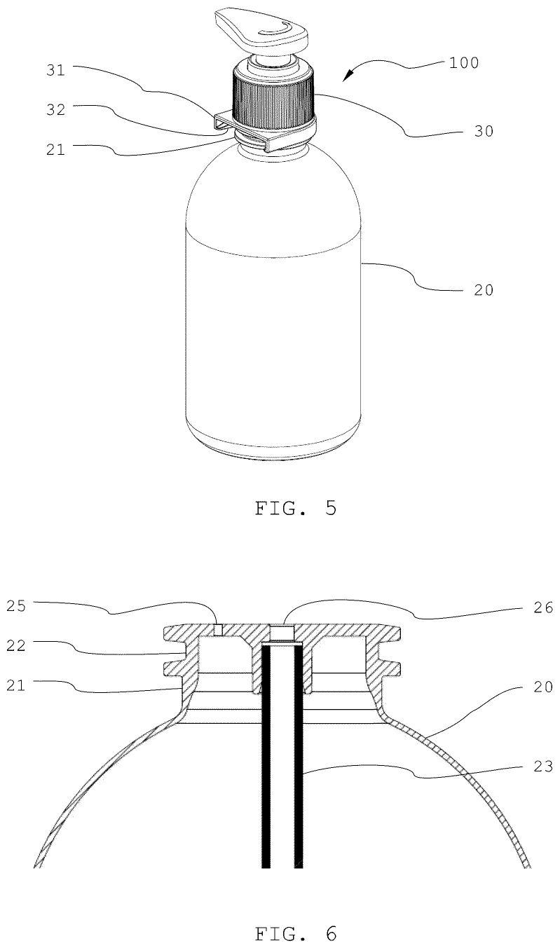

FIGS. 4A and 4B: show a flexible container in a perspective representation and a side representation;

FIG. 5: shows a further embodiment of a system;

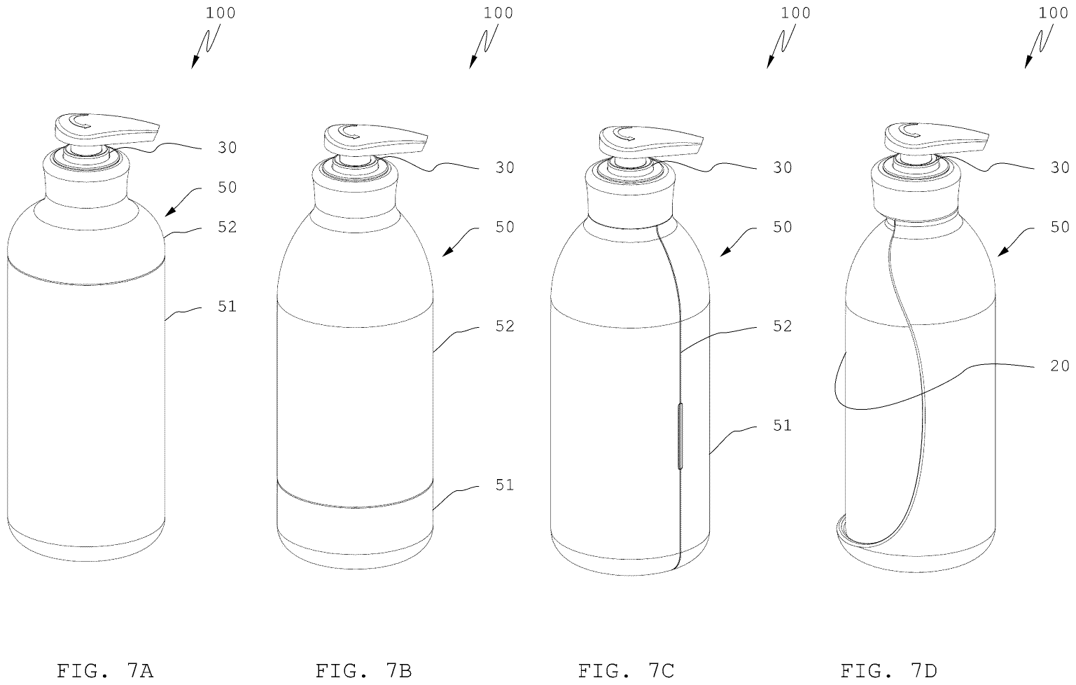

FIG. 6: shows an enlarged representation of the sectional view from FIG. 3B;

FIGS. 7A to 7D: show a system with different embodiments of receiving devices;

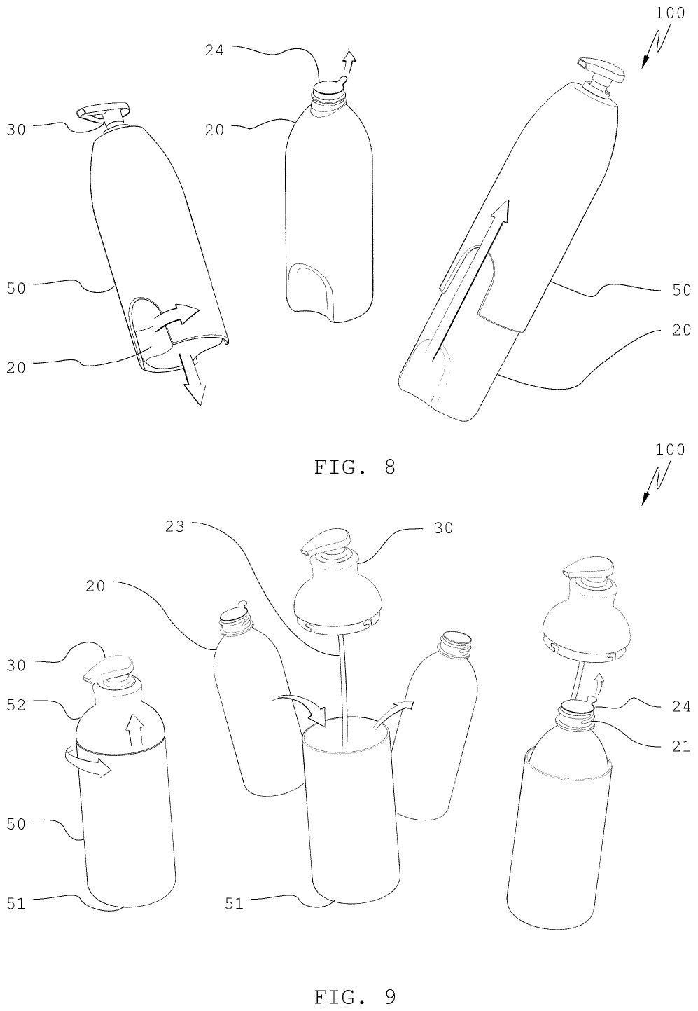

FIG. 8: shows a representation of the exchange process of a container;

FIG. 9: shows a representation of the exchange process of an alternative container;

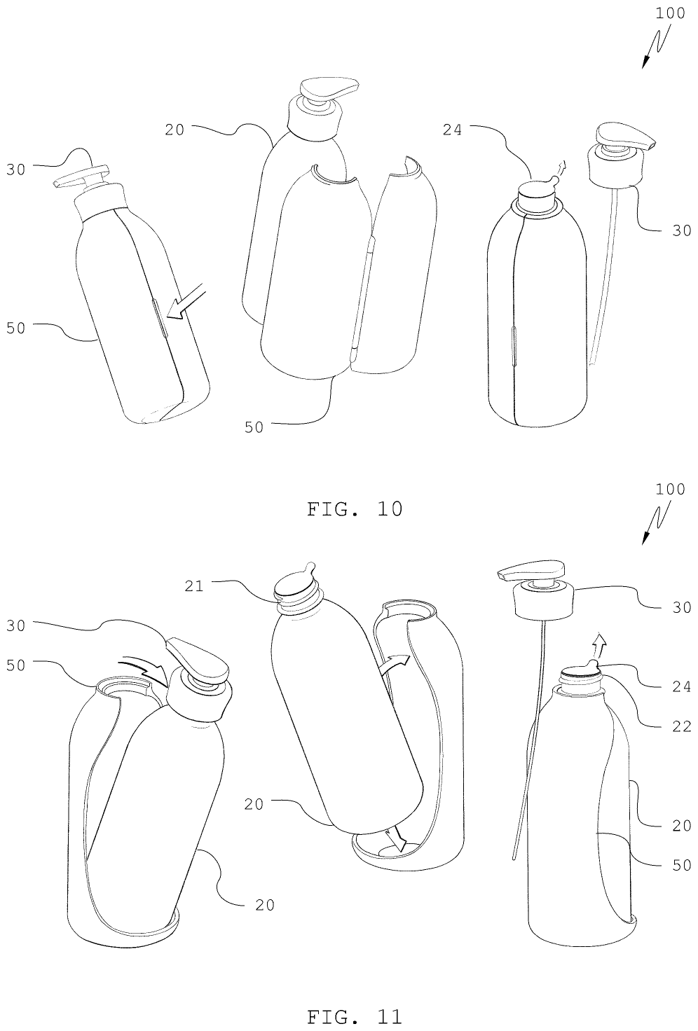

FIG. 10: shows a representation of the exchange process of an alternative container;

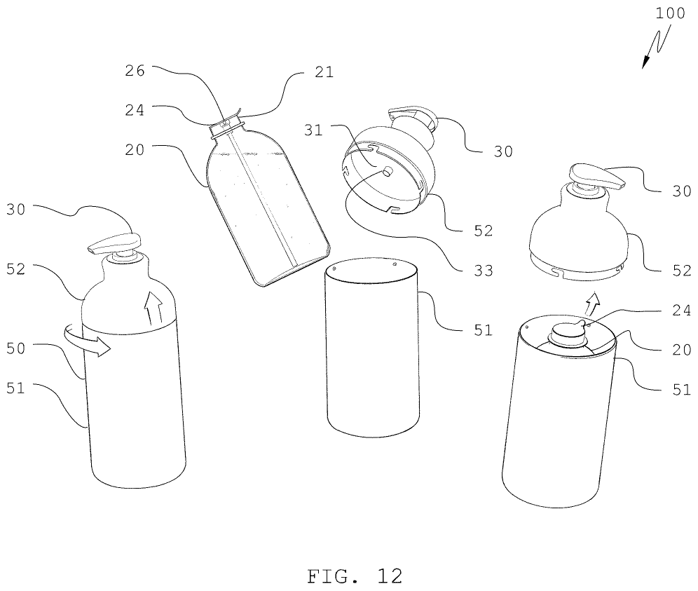

FIG. 11: shows a representation of the exchange process of an alternative container;

FIG. 12: shows a representation of the exchange process of an alternative container.

FIG. 1 shows a perspective view of a system 100 together with a receiving device 50. The receiving device 50 is designed in two parts and has a receiving part 51 and a closing part 52. A container 20 (see FIG. 2) is situated inside the receiving device 50. The closing part 52, i.e. a component of the receiving device 50, is designed in the present case as a component of the dispensing device 30. In other words, the dispensing device 30 is situated on the receiving device 50 and is non-detachably connected to it. In the present case, the dispensing device 30 is designed as a pump dispenser.

FIG. 2 shows a sectional view through the system 100 according to FIG. 1. However, the section only extends through the receiving part 51, such that the container 20 located in the receiving device 50 can be seen. The container 20 is designed as a dimensionally stable container. A riser tube 23 is situated in the interior of the container 20. At its upper end, the container 20 has a main body 21 for operative connection with a corresponding connection element 31 of the dispensing device 30. For this purpose, engagement means 22 are provided on the main body 21, which engage with complementary engagement means 32 on the connection element 31. The engagement means 22, 32 shown in FIG. 2 are designed as a slide-on connection.

The riser tube 23 is situated inside the container 20 on the main body 21 and is in fluidic connection with a corresponding opening on the main body 21 (see also FIG. 6). The connection element 31 also has a corresponding opening, such that a product can be dispensed from the interior of the container 20 through the dispensing device 30 in the ready-for-use state.

By engagement of the engagement means 22, 32, a fluid-tight connection is produced between the main body 21 and the connection element 31. The engagement means 22 and 32 are designed in such a way that they press two sealing surfaces together, which are each situated on the main body 21 and the connection element 32.

FIGS. 3A and 3B show a dimensionally stable container 20 in a side view and a sectional representation. The container 20 has a main body 21 at its upper end. Engagement means 22 are situated on the main body 21. In the present case, the engagement means 22 are designed as a circumferential groove into which a corresponding counterpart can be inserted laterally. A riser tube 23 is situated inside the container 20 and is fastened to the main body 21. The riser tube 23 extends to the base, not described in more detail, of the container 20, such that the product to be dispensed can be dispensed from the container 20 by means of the generic type of connection with a dispensing device. The riser tube 23 can, for example, be fastened to a separate closure element that is snapped into an opening of the container 20.

FIGS. 4A and 4B show a container 20 that is designed as a flexible pouch. The container 20 also has a main body 21 at its upper end for engagement with a corresponding connection element. The engagement means not shown here are designed analogously to the engagement means shown in FIGS. 3A and 3B. Since the container 20 shown in the present case is designed as a flexible pouch, a riser tube inside the container 20 is dispensed with. In typical use, the pouch is connected to the dispensing device in a fluid-tight manner, an no air exchange occurs into the pouch. When the product is dispensed, the pouch contracts, such that it can essentially be emptied completely.

FIG. 5 shows a further embodiment of the system 100, wherein the system 100 shown in FIG. 5 is situated on a container 20 according to FIGS. 3A and 3B. The system 100 has a dispensing device 30, which has a connection element 31. The container 20 has a main body 21. The connection element 31 is in operative connection with the main body 21. For this purpose, the main body 21 and the connection element 31 have complementary engagement means 22 (see FIG. 6) and 32. As already shown, the engagement means 22 are designed as a circumferential groove on the container 20. Accordingly, the engagement means 32 on the dispensing device 30 are designed as a projection for engagement in the corresponding groove. The main body 21 and the connection element 31 and in particular the engagement means 22 and 32 are designed as a slide-on connection for lateral insertion.

FIG. 6 shows an enlarged representation of the sectional view in FIG. 3B. The section through the main body 21 and the engagement means 22 located therein can be seen. The main body 21 closes the container 20. An opening 26 is situated in the main body 21 for removing a product from the container 20. A riser tube 23 is situated opposite this opening 26 and extends into the interior of the container 20. The main body 21 also has a ventilation opening 25, such that a negative pressure in the interior of the container 20 can be prevented when a product is being removed from the container 20.

FIGS. 7A to 7D show a system 100 with different embodiments of receiving devices 50. FIG. 7A shows a receiving device 50 as already described in the previous figures. The receiving device 50 is designed in two parts and has a receiving part 51 and a closing part 52. The closing part 52 is non-detachably connected to the dispensing device 30. A separation point between the receiving part 51 and the closing part 52 is located in the upper region of the receiving device 50.

FIG. 7B shows a receiving device 50, which also has a receiving part 51 and a closing part 52. Here too, the closing part 52 is non-detachably connected to the dispensing device 30. A separation point between the receiving part 51 and the closing part 52 is located in the lower region of the receiving device 50.

FIG. 7C shows a receiving device 50, which likewise is in two parts. However, in contrast to the receiving devices shown in FIGS. 7A and 7B, there is a separation point along the longitudinal axis. A hinge, which is not visible here, is situated opposite, such that the receiving device 50 can be opened like a book. In this embodiment, the dispensing device 30 is designed independently of the receiving device 50.

FIG. 7D shows a receiving device 50 that is designed in one piece. However, this receiving device 50 is open in a lateral region, such that a container 20 can be inserted laterally. In this embodiment as well, the dispensing device 30 is designed independently of the receiving device 50.

FIG. 8 shows a representation of an exchange process of a container 20. In this exemplary embodiment, the receiving device 50 is designed in one piece and is non-detachably connected to the dispensing device 30. In the typical position of use, the receiving device 50 is open at the bottom. A container 20 can be inserted into this opening from below. In a first step, an emptied container 20 is removed from the receiving device 50 and correspondingly separated from the dispensing device 30. For this purpose, the container 20 is rotated about its longitudinal axis and then pulled out of the receiving device 50 in the direction of the longitudinal axis. The engagement means 22 and 32, which are not shown here, can accordingly be designed as a thread or as a bayonet closure. A replacement container 20 is then provided. This is typically sealed with a sealing film 24. This is removed. This replacement container 20 is then pushed back into the receiving device 50 from below. The system 100 is now completely ready for use again, without any residues of the product having been wasted or the user and/or the reusable container, i.e. the receiving device 50, having come into contact with the product and/or having been soiled.

A sealing element can be situated in the region of the engagement means. This can be designed as a surface seal. By screwing or fastening the container to the dispensing device, this sealing element can be clamped between the two elements to create a tight connection.

Alternatively, it is also possible to provide the sealing element by means of a form fit or a force fit, for example by interlocking two conical elements, for example a conical connecting piece into a corresponding conical opening. A corresponding sealing effect can be produced by attaching the container axially to the dispensing device and holding it by means of a thread or bayonet closure.

In particular when connecting with a bayonet closure, this is designed in such a way that a preload is applied to the sealing element or to the connecting piece.

FIG. 9 shows a further representation of an exchange process of a container 20. In this exemplary embodiment, the receiving device 50 is designed as described for FIGS. 1, 2 and 7A. The receiving device 50 is designed in two parts and has a receiving part 51 and a closing part 52. The dispensing device 30 is non-detachably connected to the closing part 52; the closing part 52 thus forms a component of the dispensing device 30. The closing part 52 and the receiving part 51 are connected to one another with a bayonet closure. In other words, in a first step, the receiving device 50 is opened by turning the closing part 52 and lifting it away from the receiving part 51. Alternatively, a thread could also be provided.

As can be seen from the middle representation in FIG. 9, a riser tube 23, which can be inserted into the container 20, is arranged on the dispensing device 30. An empty container 20 is removed from the receiving part 51 and a new, unopened container 20 is inserted into the receiving part 51. The unopened container 20 has been sealed with a sealing film 24, which is then removed. A main body 21 is situated on the container 20, which has engagement means not described in more detail here. These engagement means are designed as a thread in the present case. A corresponding mating thread is located on the dispensing device 30. Before the closing part 52 is placed on the receiving part 51, the container 20 is screwed into the dispensing device 30. The dispensing device 30 together with the container 20 is then inserted into the receiving part 51 and the receiving part 51 is closed with the closing part 52.

FIG. 10 shows a further representation of an exchange process of a container 20. In this exemplary embodiment, the receiving device 50 is designed as described in FIG. 7C. The receiving device 50 is designed in two parts and has two halves, wherein these halves are connected to one another by a hinge. To replace a container 20, the receiving device 50, or the two halves of the receiving device 50, is opened and the container 20 is removed from the receiving device 50 together with the dispensing device 30 fastened to it. In this embodiment as well, a riser tube is situated on the dispensing device 30, which riser tube can be inserted into a replacement container 20. The replacement container 20 is also sealed with a sealing film 24 that is removed prior to use. The container 20 can be inserted into the receiving device 50 and connected to the dispensing device 30. A main body with engagement means is provided on the container 20. Engagement means are also provided on the dispensing device 30 on a connection element 31. These can be designed as described in the present case.

FIG. 11 shows a further representation of an exchange process of a container 20. In this exemplary embodiment, the receiving device 50 is designed as described in FIG. 7D. In other words, the receiving device 50 has a lateral or side opening and is designed in one piece. In order to replace a used container 20, it is pivoted laterally out of the receiving device 50 together with the dispensing device 30 and the container 20 is separated from the dispensing device 30. A new container 20 is inserted laterally into the receiving device 50. This has also been sealed with a sealing film 24 which is removed prior to use. It can be seen that the container 20 according to the present exemplary embodiment has a main body 21 on which engagement means 22 are situated, which are designed as a thread. In the present embodiment as well, the dispensing device has a riser tube for insertion into the container 20.

FIG. 12 shows a further representation of an exchange process of a container 20. In this exemplary embodiment, the receiving device 50 is designed as described for FIGS. 1, 2 and 7A. However, the system for connecting the container 20 to the dispensing device 30 is designed differently. The receiving device 50 is designed in two parts and has a receiving part 51 and a closing part 52. The closing part 52 is non-detachably connected to the dispensing device 30 and constitutes a component of the dispensing device 30. To open the receiving device 50, the closing part 52 is rotated relative to the receiving part 51 and lifted away from it. An empty container 20 is removed and a full container 20 is inserted into the receiving part 51. The full container 20 is shown in section in the present case, and the level of the product can be seen inside the container 20. The new container 20 has been sealed with a sealing film 24. A connecting piece 33 is situated on the dispensing device 30 as engagement means of the connecting means 31 for engagement in a corresponding opening 26 on the main body 21. In other words, the engagement means are designed in the present case as a plug-in connection. A fluid-tight connection is created by inserting the connecting piece 33 into the corresponding opening 26. For this purpose, the closing part 52 is placed on the receiving part 50 in the axial direction and the connecting piece 33 is pushed into the opening 26 in the container 20. The connecting piece 33 and the opening 26 are designed to be conical for this purpose. The closing part 52 is twisted relative to the receiving part 51 and secured. In the present case, the connection between the receiving part 51 and the closing part 52 is designed as a bayonet closure. The system 100 is now completely ready for use again, without any residues of the product having been wasted or the user and/or the reusable container, i.e. the receiving device 50, having come into contact with the product and/or having been soiled.

In order to provide a good sealing effect, the receiving device 50 in its assembled state has an extension in its interior between its base and the connection element 31, which is shorter than an associated extension of the container 20, such that the container 20 is clamped inside the receiving device 50. Accordingly, a force is applied to the connecting piece 33, which presses it into the opening 26.

1. A system (100) for connecting a container (20) to a dispensing device (30), comprising
a main body (21) situated on the container (20), and a connection element (31) situated on the dispensing device (30), wherein the connection element (31) is in operative connection with, or can be brought into operative connection with, the main body (21), wherein mutually complementary engagement means (22, 32) are situated on the main body (21) and on the connection element (31) such that a fluid-tight connection is produced between the main body (21) and the connection element (31) when the engagement means (22, 32) mutually engage.

2. The system (100) according to claim 1, wherein the system (100) has a sealing element for producing the fluid-tight connection.

3. The system (100) according to claim 2, wherein the sealing element is situated on the main body (21).

4. The system (100) according to claim 2, wherein the sealing element is situated on the connection element (31).

5. The system (100) according to claim 2, wherein the sealing element is designed as a surface seal.

6. The system (100) according to claim 1, wherein the container (20) is designed as a flexible bag.

7. The system (100) according to claim 1, wherein the container (20) is designed as a dimensionally stable container.

8. The system (100) according to claim 7, wherein a riser tube (23) is situated in the dimensionally stable container.

9. The system (100) according to claim 1, wherein the engagement means (22, 32) are designed as a screwed connection.

10. The system (100) according to claim 1, wherein the engagement means (22, 32) are designed as a slide-on connection.

11. The system (100) according to claim 1, wherein the engagement means (22, 32) are designed as a plug-in connection.

12. The system (100) according to claim 1, wherein the engagement means (22, 32) are designed as a bayonet closure.

13. The system (100) according to claim 1, wherein a projection and/or a constriction is formed on the engagement means (22, 32) for producing a snap connection.

14. The system (100) according to claim 1, wherein the main body (21) is non-detachably connected to the container (20), in particular is an integral component.

15. The system (100) according to claim 1, wherein the dispensing device (30) is designed as a metering closure, in particular as a pump dispenser or as a spray dispenser.

16. The system (100) according to claim 1, further comprising a receiving device (50) for receiving the container (20).

17. The system (100) according to claim 16, wherein the dispensing device (30) is situated on the receiving device (50).

18. The system (100) according to claim 17, wherein the receiving device (50) has, in its interior, an extension between a base and the connection element (31) of the dispensing device (30), which is shorter than an associated extension of a container (20), such that the container (20) can be clamped inside the receiving device (50).

19. A container (20) for use in a system (100) according to claim 1, wherein the container (20) comprises a main body (21) for connection to a connection element (31) situated on a dispensing device (30), wherein engagement means (22) are situated on the main body (21), which engagement means can be brought into engagement with complementary engagement means (32) on the connection element (32).

20. The container (20) according to claim 19, wherein the container (20) is designed as a flexible pouch.

21. The container (20) according to claim 20, wherein the container (20) is designed as a dimensionally stable container.

22. The container (20) according to claim 21, wherein a riser tube (23) is situated in the dimensionally stable container.

23. The container (20) according to claim 19, wherein the engagement means (22) are designed as one half of a screwed connection.

24. The container (20) according to claim 19, wherein the engagement means (22) are designed as one half of a slide-on connection.

25. The container (20) according to claim 19, wherein the engagement means (22) are designed as one half of a bayonet closure.

26. The container (20) according to claim 19, wherein the engagement means (22) are designed as one half of a plug-in connection.

27. The container (20) according to claim 19, wherein a projection and/or a constriction is formed on the engagement means (22) for producing a snap connection.

28. The container (20) according to claim 19, wherein the main body (21) is non-detachably connected to the container (20), in particular is an integral component.

29. A receiving device (50) for receiving the container (20) according to claim 19, wherein that the receiving device (50) comprises a dispensing device (30).

30. The receiving device (50) according to claim 29, wherein it is formed from two components.

31. The receiving device (50) according to claim 30, wherein these components form a receiving part (51) and a closing part (52), wherein the dispensing device (30) is situated on the closing part (52).

32. The receiving device (50) according to claim 31, wherein the closing part (52) and the receiving part (51) are connected to one another via a bayonet closure or a screwed connection.

33. The receiving device (50) according to claim 31, wherein the receiving device (50) has, in its interior, an extension between a base and the connection element (31) of the dispensing device (30), which is shorter than an associated extension of a container (20), such that the container (20) can be clamped inside the receiving device (50).
